(19) United States
(12) Patent Application Publication
(10) Pub. No.: US 2014/0348156 A1
(43) Pub. Date: Nov. 27, 2014

(54) OPTIMIZING ROUTE SELECTION BASED ON TRANSCODING

(71) Applicant: Rogers Communications Inc., Toronto (CA)

(72) Inventors: Paul Borong Zheng, Markham (CA); Luojun JIN, Waterloo (CA)

(73) Assignee: Rogers Communications Inc., Toronto (CA)

(21) Appl. No.: 13/899,684

(22) Filed: May 22, 2013

(51) Int. Cl. H04L 12/725

(52) U.S. Cl. CPC H04L 45/30
USPC 370/352

(57) ABSTRACT

Disclosed is a method of selecting a route for data transmission. The method comprises: receiving an ingress codec profile and an identification of a destination; determining whether there is a matching codec pair that includes a codec that is identified in both the ingress codec profile and one or more egress codec profile; identifying one or more compatible codec pairs between the codecs listed in the ingress codec profile and the codecs listed in the egress codec profiles associated with egress trunk groups; prioritizing a list of codec pairs, each codec pair in the list of codec pairs comprising a codec identified in the ingress codec profile and a codec identified in an egress codec profile; and, selecting one trunk group from the egress trunk group list, the selected trunk group having a codec profile that comprises a codec from a codec pair in the prioritized list of codec pairs.

### TECHNICAL FIELD

The present disclosure relates to communication systems and, more particularly, to selecting an optimal route for a transmission of data.

### BACKGROUND

Different data carriers may be transitioning from legacy time division multiplexing to Internet Protocol (“IP”). Transcoding may be implemented in order to manage this transition. Further, incoming data transmissions may be encoded according to a different codec (“Coding Decoding”) standard than the outgoing data transmission. In such situations transcoding may be required to convert the incoming data to a format that is compatible with the outgoing codec.

In some situations, voice over Internet protocol (“VoIP”) may be implemented to transmit audio or visual data. Transcoding the audio or visual data may result in a degradation of the quality of the data.

### BRIEF DESCRIPTION OF THE DRAWINGS

Reference will now be made, bay way of example, to the accompanying drawings which show example embodiments of the present application and in which:

FIG. 1 is a block diagram of an exemplary communication system.

FIG. 2 is a block diagram of an exemplary call server and some associated components.

FIG. 3 is a flowchart showing a method of selecting a route for an ingress transmission.

FIG. 4 is a flowchart showing another embodiment of a method of selecting a route for an ingress transmission.

### DETAILED DESCRIPTION OF EXAMPLE EMBODIMENTS

In one aspect, disclosed is a method of selecting a route for an ingress transmission from an egress trunk group list, the egress trunk group list identifying one or more egress trunk groups, the method comprising: receiving an ingress codec profile and an identification of a destination, the ingress codec profile comprising an identification of one or more codecs; determining whether there is a matching codec pair, a matching codec pair comprising a codec that is identified in both the ingress codec profile and one or more egress codec profile, the egress codec profiles associated with the egress trunk groups identified in the egress trunk group list; identifying one or more compatible codec pairs between the codecs listed in the ingress codec profile and the codecs listed in the egress codec profiles associated with the egress trunk groups identified in the egress trunk group list; prioritizing a list of codec pairs, each codec pair in the list of codec pairs comprising a codec identified in the ingress codec profile and a codec identified in an egress codec profile, the prioritization based on the determination of matching codec pairs and the determination of compatible codec pairs; and, selecting one trunk group from the egress trunk group list, the selected trunk group having a codec profile that comprises a codec from a codec pair in the prioritized list of codec pairs.

In another aspect, disclosed is A call server for selecting a route for an ingress transmission from an egress trunk group list, the call server configured to: receive an ingress codec profile and an identification of a destination, the ingress codec profile comprising an identification of one or more codecs; determine whether there is a matching codec pair, a matching codec pair comprising a codec that is identified in both the ingress codec profile and one or more egress codec profile, the egress codec profiles associated with the egress trunk groups identified in the egress trunk group list; identify one or more compatible codec pairs between the codecs listed in the ingress codec profile and the codecs listed in the egress codec profiles associated with the egress trunk groups identified in the egress trunk group list; prioritize a list of codec pairs, each codec pair in the list of codec pairs comprising a codec identified in the ingress codec profile and a codec identified in an egress codec profile, the prioritization based on the determination of matching codec pairs and the determination of compatible codec pairs; and, select one trunk group from the egress trunk group list, the selected trunk group having a codec profile that comprises a codec from a codec pair in the prioritized list of codec pairs.

Other example embodiments of the present disclosure will be apparent to those of ordinary skill in the art from a review of the following detailed description in conjunction with the drawings.

### Exemplary Communication System

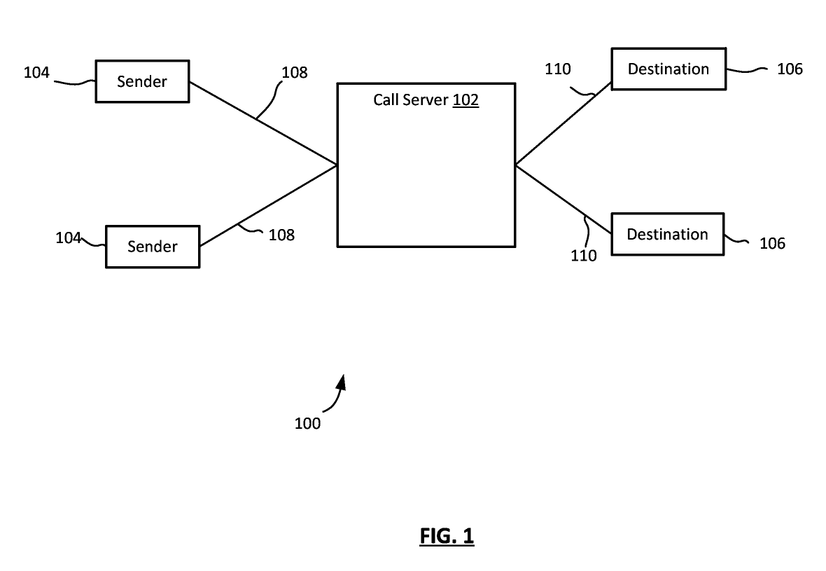

FIG. 1 is a block diagram of an exemplary communication system 100. The communication system 100 can be used to initialize a data transmission between end points. The data transmission can be an audio or video transmission such as VoIP. The communication system 100 can also be used to manage the ongoing transmission of data between the end points and to complete the data transmission. The communication system 100 can be implemented over a network such as the internet.

The communication system 100 includes a call server 102 one or more senders 104 and one or more destinations 106. The senders 104 are connected to the call server 102 through a transmission medium 108. The call server 102 is connected to the destinations 106 through a transmission medium 110. Data may be transferred or transmitted between the sender(s) 104 and the call server 102 along transmission medium 108. Similarly, data may be transferred or transmitted between the call server 102 and the destination(s) along transmission medium 110. The call server 102 may be configured to manage or oversee the transmission of data along transmission mediums 108, 110.

The call server 102 is a component of the communication system 100 and can be configured to manage data transmissions between the end points. Similarly, the call server 102 can be configured to manage the initial data transmission from an end point that is used to establish a communication channel with a second end point. The end points may also be referred to as trunk agents or termination points. The end points can be implemented on or can include electronic devices, such as a mobile phone, cellular phone, smart phone, pager, etc. Alternatively, the end points can be separate components configured to transmit data to one or more electronic devices. Further, different destinations or end points can be configured to transmit data to the same device.

In one or more embodiments, the call server 102 may be used to manage VoIP transmissions or multimedia transmissions between endpoints. In other words the data transmission may be in accordance with VoIP. For example, the call server 102 may be a back-to-back user agent (B2BUA) which can operate in Session Initiation Protocol (SIP) applications. While operating as a B2BUA, the call server 102 can manage data transmissions between the end points of a phone call or data communication session. The end points may be identified as trunk agents, originating and terminating trunk agents, for example. In FIG. 1, the end points are identified as sender 104 and destination 106. The B2BUA (e.g. the call server 102) can mediate the SIP signalling between both end points of a phone call and such mediation may occur between (and including) call establishment and call termination. By way of further example, any messages (such as a control message) passing between the end points of a phone call (or during a VoIP transmission) can flow through the B2BUA (or the call server 102 as the case may be). As such, the B2BUA may be configured to intercept, monitor or alter messages or transmissions that pass between the end points of an established transmission channel. An established transmission channel may include a transmission channel coordinated or arranged by the call server 102, for example. Accordingly, when a transmission channel is established, data (e.g. voice or audio data) may be transmitted on the transmission channel between the end points. For example, the transmission channel may be implemented between the sender 104 and the destination 106 along transmission mediums 108, 110. In one or more embodiments, multiple transmission channels may be implemented on transmission mediums 108, 110. Similarly, multiple endpoints may be configured to transmit data along or over transmission mediums 108, 110.

The call server 102 may be configured to monitor or collect information associated with data transmission for billing purposes or data collection purposes, or otherwise. The call server 102 may also be configured to route calls, normalize addresses, and authenticate and authorize routing decisions. The call server 102 may also be configured to hide network information such as the network topology and addresses of network components. The network information may be associated with the communication system 100. The call server 102 can include a processor and a memory. For example, the memory may store instructions that can be executed by the processor for carrying out one or more methods or processes or for executing applications. In accordance with exemplary embodiments, the call server 102 is a physical component (i.e. hardware) of the communication system 100.

The end points of a phone call or of a VoIP transmission are shown in FIG. 1 as senders 104 and destinations 106. The senders 104 may be the call originator and may transmit a call request or an ingress transmission along transmission medium 108 to the call server 102. As noted, the end points can be associated phones, cellular telephones, smart phones, tablet computers, or other electronic communication devices. The end points can be operated by one or more different carriers (or operators). Similarly, each end point may be associated with one or more trunk groups (at least for the purpose of or during data transmissions), which themselves are associated with and may be controlled by the respective carriers.

After a call (e.g. a transmission channel) is established between the sender 104 and destination 106, as managed by the call server 102, the data (e.g. voice data) may be transmitted between sender 104 and destination 106 along or over transmission mediums 108, 110. When a call is established a transmission channel may be made available for the sender 104 and destination 106 to communicate data across. The transmission channel may be implemented on or within transport mediums 108, 110. For example, a sender 104 may receive data from or send data to a call server 102 along transport medium 108. And, a destination 106 may receive data from or send data to a call server 102 along transport medium 110. The transport mediums 108, 110 can be cables, wireless, or wired connections, for example. By way of further example, the transport mediums 108, 110 may be a network, such as the Internet, that can operate using a protocol such as TCP/IP or VoIP.

There may be more than one sender 104 configured to transmit and receive data over the transmission medium 108. Similarly, there may be more than one destination 106 configured to transmit and receive data over the transmission medium 110. Trunking may be used in order to allow each end point (e.g. the senders 104 and destinations 106) to transmit data over a transmission medium. For example, multiple senders 104 may be able to share the same set of frequencies rather than having to use separate individual frequencies for each sender 104.

Trunking may be implemented by using trunk groups. Each trunk group may be managed by an operator or carrier. For example, there may be one or more trunk group that can be implemented for transmitting data to a destination.

In accordance with one or more embodiments, a trunk is a single communication channel between two points. The trunk can consist for three elements: a near end point (e.g. call server 102 or a media gateway controlled by call server 102), a far end point (e.g., sender 104 or destination 106), and a transport medium 108, 110 in between the near end point and the far end point. A trunk group is a group of trunks that have the same or similar media attributes and can serve the same communication purposes of reaching a specific group of destinations 106.

The destination 106 (or sender 104) can be a phone, cellular telephone, smart phone, tablet computer, or another electronic communication device. The destination 106 (or sender 104) can also represent a network 100 with end points that are operated by one or more different carriers (or operators). The sender 104 can transmit a communication request to the call server 102. When the communication request is received, the call server 102 (or an associated network component) can determine which trunk group to use to implement a communication channel between the sender 104 and the destination 106. The determination of which trunk group to use can be based on one or more attributes associated with the communication request. After the trunk group is determined, a trunk can be selected from the available trunks within the trunk group.

Each trunk group may be associated with a codec profile. A codec profile identifies all of the codecs that are supported by the associated trunk group. For example, if one point of a trunk group (e.g. near end point or far end point) is capable of transmitting data encoded following a specific codec, and the other point of a the trunk group is capable of receiving and decoding the received data following the specific codec, then that codec can be identified in the codec profile of the trunk group.

A codec is used herein to refer to the implementation of a type of encoding or coding of data. In one or more embodiments, codec may be used to refer to the format of encoding or decoding data. In one or more embodiments, codec may be used to refer to the capability of a device or computer program to encode and decode a digital data stream or signal. For example, the digital data stream or signal can be encoded (in accordance with the codec) for transmission or encryption or decoded (in accordance with the codec) for playback, or both.

In one or more embodiments, data transmissions are encoded at the ingress trunk group (or at a component associated with the ingress trunk group). For example, the carrier or operator may encode the data or may oversee the encoding of the data. The codec profile may be stored, maintained or updated by the operator, for example. The codecs that are allowed to be used for the encoding or decoding can be identified in the codec profile of the ingress trunk group. The codecs that are allowed to be used may be those codecs capable of encoding or decoding at the sender 104 that have been approved by operator (or carrier) of the sender 104. The codec that is actually used at the sender 104 can be included in the incoming transmission request to the call server 102. Similarly, the data transmissions may be encoded or decoded at the egress trunk group (or at a component associated with the egress trunk group). The codec(s) that the egress trunk group is capable of encoding or decoding may be identified in the codec profile of the egress trunk group ad may also be stored in a memory associated with the operator.

The codec profiles may be automatically determined, or they may be manually recorded (or manually input). The codec profiles may be periodically updated to reflect changing circumstances with respect to the associated trunk group (codec profiles may be associated with one or more trunk groups, for example). The codec profile can include an identification of one or more codecs that are supported by the associated trunk group. A codec is supported at an egress trunk group if it data encoded using that codec at a point (e.g. the far end point) can be decoded at another point (e.g. the near end point) that egress trunk group. In another example, a codec is supported at an egress trunk group if that trunk group (or an associated component) is willing to (or is programed to) encode in accordance with that codec. This identification can be a list of codecs, for example, which may all be supported codecs. The supported codec(s) can be identified by the carrier or operator for the associated trunk group. For example, the supported codec can be identified in an agreement between the carrier (e.g. the operator of an end point or point of a trunk group) and the operator of the call server 102 (e.g. the operator of the other end point of the trunk group). Alternatively, the supported codec may be derived from the carrier platform capability (or the associated trunk group capability).

There may be situations in which the transmission of data from an ingress component (e.g. from the sender 104) is in an encoding that is not supported at an egress trunk group that can be used to transmit data to the destination 106. For example, the codec profile associated with the egress trunk group may not identify the encoding that was used to encode the transmission of data from the sender 104. In such a situation, the transmission of data from the sender 104 can be transcoded into an encoding that is used at an egress trunk group. In other words the transmission of data can be transcoded into an encoding that is included in the codec profile associated with the egress trunk group. The transcoding may occur at the call server 102. Alternatively, the transcoding may be implemented at one of the media gateway of the trunk groups or at one of the end points or may be implemented by carriers or operators of the trunk groups. As a result of a transcoding operation the data can be converted from one codec to a different codec.

Transcoding may cause various degree of quality impairment on the stream of data being transmitted depending on codes used to encode the data. A transcoding policy may be associated with one or more end points or trunk groups. The transcoding policy associated with a trunk group dictates the transcoding rules associated with that trunk group. For example, the transcoding policy may identify the transcodings (e.g. by identifying the codecs being transcoded) that are acceptable to implement for use on the associated trunk group. Further, the transcoding policy may indicate the relative priority of transcodings for use on the associated trunk group. For example, on transcoding may have a higher priority than another transcoding and therefore may be more desirable. For example, a transcoding that has a higher priority may be a transcoding that more desirable to be used. The transcoding policy may be defined by the operator of the associated trunk group and may also be stored in a memory associated with the operator. Or, the transcoding policy may be defined in an agreement with the operator of the call server 102. Or, the transcoding policy may be determined by a quality of service target associated with the operator of a trunk group. In an alternative embodiment, the transcoding policy can be communicated to the call server 102 by sender 104 or destination 106 during a session setup process. In an embodiment, call server 102 might query sender 104 or destination 106 for transcoding policy.

The transcoding policies (e.g. for the egress trunk group(s)) may be made available to the call server 102. When an initial transmission is received from a sender 104, the transmission may include a list of preferred codecs supported by the sender 104 as well as an identification of the transcoding policy of the sender 104. For example, the identification of the transcoding policy may be an indication of where the transcoding policy may be available to the call server 102 (e.g. in a memory associated with the call server 102). The initial transmission may also identify the destination 106 (or of another end point with which to establish a transmission channel) or may instruct the call server 102 how to identify the destination 106 (e.g. by identifying a location in memory that stores the required information to identify the destination 106). For example, the indication of the transcoding policy of the sender 104 may identify or describe the sender's transcoding policy (or a transcoding policy that the sender is using, for example).

The call server 102 may be configured to determine or establish a transmission route or transmission channel between the sender 104 and the destination 106 (or between two end points). The transmission route may consist of an ingress trunk group and an egress trunk group. The determination may be performed based on the transcoding policy of the destination 106 or the sender 104 or both. The determination may also be made based on the codec policy of potential egress trunk groups. For example, the call server 102 may be configured to select an egress trunk group based on the transcoding policy associated with the egress trunk group and the codec policy associated with the egress trunk group. The call server 102 may also consider one or both of the transcoding policy associated with the ingress trunk group and the codec profile associated with the ingress trunk group.

In one or more embodiments, the call server 102 may also select an egress trunk group (for transmitting data to and receiving data from the destination 106) based on data received in the ingress transmission and on known properties of the communication system 100 (or an associated communication network) and on known properties of the destination 106.

The sender 104 may initiate the call by transmitting a call request to the call server 102. The call request can include an identification of the sender 104 and an identification of the destination 106. In one or more embodiments, the call server 102 can propose an egress trunk group to sender 104, or the call server 102 can negotiate with the sender 104 to determine the identification of the egress trunk group to use for the subsequent transmission (e.g. the VoIP transmission).

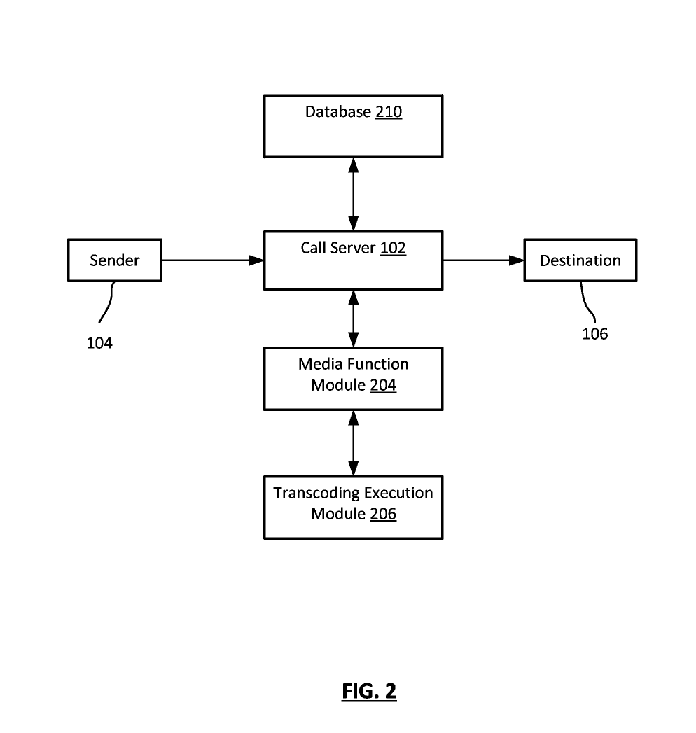

The call server 102 and some associated components are shown in more detail in the block diagram of FIG. 2.

FIG. 2 is a detailed block diagram of the call server 102 of FIG. 1. The call server 102 is associated with a number of components, such as a database 210, a media function module 204 and a transcoding execution module 206. The components (including the call server 102) can be in different locations or may be implemented in the call server 102. For example, the database 210, the media function module 204 and the transcoding execution module 206 may be implemented as software in the call server 102. The components shown in FIG. 2 may not exhaustively identify all of the components used in association with the call server 102. In one or more embodiments, the transcoding execution module 206 could also be implemented in media function module 204.

The media function module 204 can include hardware or software components (or both) that can be used to establish a communication or transmission channel between the end points of a call. For example, the call server 102 may coordinate with or instruct the media function module 204 to provision transmission between the end points on selected trunk groups. For example, the media function module 204 can be a translation device that converts and isolates digital media streams between disparate telecommunication networks (such as TDM to IP, IP to IP, wireless to wireline). The media function module 204 may also be configured to isolate networks between telecommunication operators to provide protection from outside extruders and unwanted internet access (e.g. internet fraud). The media function module 204 may also be identified as a media gateway.

The transcoding execution module 206 can include hardware or software components (or both) that can be used to carry out or execute codec conversion. For example, the call server 102 may coordinate with or instruct the transcoding execution module 206 to execute transcoding between two or more codecs. Such transcoding may be implemented in order to accommodate the transmission of data between an ingress trunk group (associated with the sender 104) and an egress trunk group (associated with the destination 106). For example, the transcoding execution module 206 may process the ingress transmission such that the result is in a codec suitable for the egress trunk group.

The database 210 is configured to store data that can be accessed by the call server 102 (or other network components). The data stored in the database may also be accessed by one or more other components associated with the call server 102. The call server 102 may also instruct the database 210 to store certain data related to data transmission that is managed by the call server 102. For example, the database 210 may store network topology information or the database 210 may store data collected in relation to the transmission of data across a transmission channel (e.g. in real time). The database 210 may include a data repository for trunk group codec profiles or transcoding profiles or both. For example, the codec profiles for one or more trunk groups may be stored in the database 210 and may also be periodically updated. Similarly, the transcoding profiles associated with one or more trunk groups may be stored in the database 210 and may also be periodically updated.

Network components may also be associated with one or more codec profiles. The components can interconnection components, such as those used to connect different transmission routes, for example.

End points, such as the sender 104 and destination 106 may also be associated with transcoding policies.

Each time a transcoding is performed there may be a measurable degradation to one or more quality of service factors. For example, the voice quality may be degraded as a result of the transcoding.

The following are examples of factors that may contribute to a degradation of voice quality during transcoding of voice data:
1. Codec impairment amplification. Each codec can introduce distortion into the voice transmission when the voice data is encoded or decoded in accordance with the codec. There can be an inverse relationship between the bit rate of the voice data and the level of distortion on the data from the codec (or from transcoding). For example, the lower the bit rate, the higher the distortion. When transcoding happens between two different low bit rate codecs, the total distortion of the voice transmission can be amplified by the multiplication of the original distortions (of the two codecs involved in the transcoding).
2. When transcoding of an IP signal occurs, the digital IP signal must first be depacketised to reconstruct the continuous coded digital signal. This operation can introduce buffering latency. The recovered continuous signal can then be transcoded (decoded to G.711 or linear PMC, and re-encoded), then repacketised, which can incur an additional packetisation latency. The latency can compound with transcoding. The increased latency can result in lower voice data quality.

In one or more embodiments, the voice quality can be measured in Mean Opinion Score (“MOS”). MOS is a subjective value defined in ITU-T Rec. P.10/G.100, as follows: The mean of opinion scores, i.e. of the values on a predefined scale that subjects assign to their opinion of the performance of the telephone transmission system used either for conversation or for listening to spoken material. MOS score values and classifications may be as set out in the following table:

| MOS | CLASSIFICATION |
|---|---|
| 5 | Excellent |
| 4 | Good |
| 3 | Fair |
| 2 | Poor |
| 1 | Bad |

Transcoding between certain codecs could result in a MOS score lower than 3, for example.

In one or more embodiments, the quality of the voice data may be measured in E-model. E-model is defined by the ITU Rec G.107. The E-model uses transmission impairment factors that represent the effects of modern signal processing devices (including the implementation of codecs). All impairments modeled are additive (the E-model being based on psychological factors which on a psychological scale are additive). Accordingly, the impairments of transmission segments (e.g. a carrier or a service provider network) can be added to estimate end-to-end voice quality.

In accordance with an embodiment the primary output of the E-model is the Rating Factor or R (often called the R-Factor), which is composed of R=Rₒ−Iₛ−I_{d}−Iₑ+A. Where Rₒ represents in principle the basis signal-to-noise ratio, including noise sources such as circuit noise and room noise; Iₛ is a combination of all impairments which occur more or less simultaneously with the voice signal; I_{d} represents the impairments caused by delay; Iₑ is the effective equipment impairment factor and represents impairments caused by low bit-rate codecs and also includes impairment due to packet-losses of random distribution; and A is the advantage factor and allows for compensation of impairment factors when there are other advantages of access to the user.

By way of example, the transcoding between certain codecs could result in an R-factor of below 70. The R-Factor may be related to user satisfaction and to speech quality transmission.

### Exemplary Method of Selecting a Route

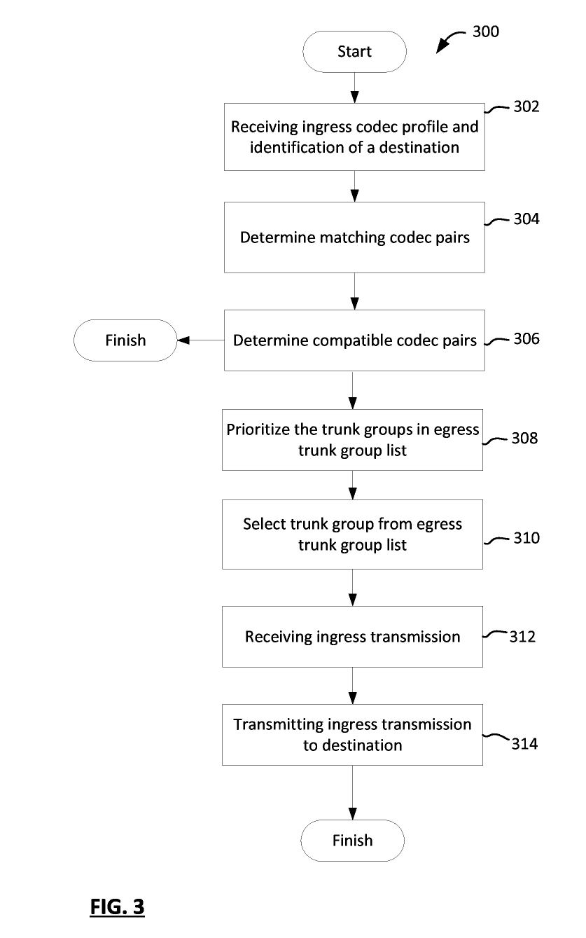

FIG. 3 is a flowchart depicting an embodiment of a method 300 of selecting a route for a transmission. For example, the route may be for an ingress transmission and may be selected from an egress trunk group list. The egress trunk group list identifies one or more egress trunk groups. The route may consist of an ingress trunk group and an egress trunk group. Or the route may consist of an egress trunk group only. In one or more embodiment the route may also be defined as including specific codecs to use on each trunk group. The route may provide a transmission channel for data (e.g. audio or visual data) to be transmitted between sender 104 and destination 106. The method 300 and its alternative embodiments can be implemented on the call server 102 described in relation to FIGS. 1 and 2. Alternatively, the method 300 and its alternative embodiments may be implemented on a processor associated with a memory. For example, the call server 102 may include a processor and a memory such that the processor is configured to execute instructions stored on the memory in order to carry out the steps of the method 300 (and 400, below) and any alternative embodiments.

At 302, an ingress codec profile and an identification of a destination 106 are received. For example, the ingress codec profile and the identification of the destination 106 can be received at the call server 102 over transmission medium 108. In an embodiment, a sender 104 may transmit the ingress codec profile and the identification of the destination 106 to the call server 102 in order to initiate a VoIP communication with the destination 106. The ingress codec profile can comprise an identification of one or more codecs that are used at one or more ingress trunk group(s). A transcoding policy associated with the sender 104 or with the ingress trunk group may also be received at the call server 102.

The ingress codec profile can be a codec profile that is associated with a sender 104. Or, the ingress codec profile can be a codec profile that is associated with an ingress trunk group as operated by a carrier or operator. The ingress codec profile can be received as an incoming transmission at the call server 102. For example, the ingress codec profile can be transmitted from the sender 104 across transmission medium 108 to the call server 102. The ingress codec profile can be received together with the identification of the destination 106. In an alternative embodiment, only an identification of the destination 106 and an identification of the sender 104 are transmitted to the call server 102. In such an embodiment, the call server 102 may already have access to the codec profile associated with the sender 104 or to the codec profile associated with the ingress trunk group, as the case may be. For example, the codec profile associated with the sender 104 (or ingress trunk group) may be stored in the database 210.

At 304, it is determined whether there is a matching codec pair. A matching codec pair comprises a codec that is identified in both the ingress codec profile and one or more egress codec profile. The egress codec profile(s) can be associated with the egress trunk groups identified in the egress trunk group list. For example, a matching codec pair may be an identification of a codec that is listed in the ingress codec profile and in an egress codec profile. The call server 102 (or an associated component) may determine all of the matching codec pairs. For example, the call server 102 may maintain a list of all of the matching codecs (if any) in a database 210 or in another memory. By way of further example, the call server 102 may compare each codec listed in the ingress codec profile with each codec listed in each egress codec profile associated with each egress trunk group that connects to the destination 106. For example, the egress codec profile can be associated with an egress trunk group and the egress trunk group can be a route to the destination 106. The identification of the egress trunk group(s) that has a codec profile that is associated with a matching codec can be stored at the call server 102 as well (and may also be stored in association with the matching codec for later retrieval).

At 306, one or more compatible codec pairs are identified. The codec pairs can include a codec listed in the ingress codec profile and a codec listed in the egress codec profile. In other words, the compatible codec pairs can be between the codecs listed in the ingress codec profile and the codecs listed in the egress codec profiles associated with the egress trunk groups. The egress trunk groups may be identified in the egress trunk group list. The egress trunk group list can be stored in the database 210 or, alternatively, it may be provided to the call server 102 by an operator of the trunk groups associated with the trunk group list. As noted, the operator may be a carrier. The trunk group list can identify one or more trunk groups that provide a transmission channel from the call server 102 to the destination (or to another end point). Each trunk group may be associated with one or more codecs. In other words, each trunk group may be configured to transmit data in accordance with one or more codecs. The codec profile for a trunk group may identify the one or more codecs that are associated with that trunk group. Similarly, the egress codec profile may identify the codecs associated with all egress trunk groups. In other words the egress codec profile may identify all codecs that are supported by the egress trunk groups.

A codec pair may be considered compatible if the call server 102 (or another network component) is configured to transcode the ingress codec to the egress codec. In other words, one codec is compatible with another codec if the call server 102 can transcode data in accordance with the former codec into data encoded in accordance with the latter codec. In another embodiment, a codec pair may be considered compatible if an effect of transcoding between the two codecs (in the codec pair) is to degrade a quality of service factor by less than a predefined amount. A codec pair may be considered compatible for capacity reasons. For example, the carrier of an international carrier operating network (which may be a communication system 100) may transcode to save capacity usage on international long haul transport.

In one or more embodiment, the identification of one or more compatible codec pairs can include identifying all of the compatible codec pairs. For example the call center 102 may compare all codecs in the ingress codec profile to all codecs in the egress codec profile to determine all compatible codec pairs. For example, the call server 102 may store a list of compatible codecs. This stored list may be used in order to determine whether any pair of codecs is compatible.

In one or more embodiments, the identification of one or more compatible codec pairs can include identifying one or more codec pairs that satisfy a transcoding policy associated with the ingress transmission. Alternative, the identification of one or more compatible codec pairs can include identifying one or more codec pairs that satisfy a transcoding policy associated with an ingress trunk group. For example, the ingress trunk group may be the trunk group on which the sender can transmit data to the call server 102.

A transcoding policy for a trunk group can include a set of rules dictating allowable or compatible transcodings. A similar transcoding policy can be associated with another component of the communication system 100 or with another network component. A transcoding policy can also be associated with more than one trunk groups. For example, a transcoding policy can be associated with the trunk groups in an egress trunk group list. The transcoding policy for a trunk group can be determined by an operator of the trunk group. For example, the operator of the ingress trunk group can be a carrier. The carrier can determine the rules that set out acceptable transcodings. For example, the carrier may determine that certain codec pairs are allowed. The carrier may update or alter the transcoding policy(s) associated with its trunk group(s) from time to time.

In one or more embodiments, the identification of one or more compatible codec pairs can include identifying one or more codec pairs that satisfy a transcoding policy associated with an egress trunk group. For example, there may be a transcoding policy associated with one or more egress trunk group that provide for transmission to the destination 106. Alternatively, the transcoding policy may be associated with the destination 106.

At 308, a list of codec pairs is prioritized. Each codec pair in the list of codec pairs can include a codec identified in the ingress codec profile and a codec identified in an egress codec profile. For example, the codec pairs can each identify two codecs, one from the ingress codec profile and one from an egress codec profile. The codec pairs can represent the codecs that could be used to transmit data between the sender 104 and the destination 106 (or two other end points). The list of codec pairs may be stored in memory (e.g. the database 210) in association with one or more egress trunk groups. For example, each codec pair may be associated with the egress trunk group(s) (i.e. the egress trunk group(s) that is configured to use or transmit the respective codec).

The prioritization of codec pairs can be based on the determination (at 304) of matching codec pairs and the determination (at 306) of compatible codec pairs. In one or more embodiments, the prioritization of codec pairs includes only matching codec pairs, or only compatible codec pairs, or both. The prioritization can be based on which pairs have the least negative effect on a quality of service factor related to the data or voice transmission. In one or more embodiments, the prioritization can be based on the effects that the implementation of the pair of codecs would on certain elements related to the data transmission (such as the level of consumption of transmission bandwidth). In one or more embodiments, the prioritization can be based on both the level of negative effect on a quality of service factor and on other elements related to the data transmission.

The list of codec pairs can be prioritized from a most desirable codec pair to a least desirable codec pair. The desirability of a codec pair can be based on one or more metric. The metric can be associated with the call server 102, ingress trunk group or egress trunk groups.

In one or more embodiments, the call server 102 can access a list of predetermined codec pairs that indicates the effect of a transcoding between each codec pair. For example, the list may indicate the effect on a quality of service factor from transcoding between the codec pairs. Negative affect on a quality of service factor such as voice degradation may result from the transcoding from one codec (e.g. as used on the ingress trunk group) to a second codec (e.g. as used on the egress trunk group).

This list of predetermined codec pairs can be compared with the determined list of codec pairs in order to prioritize the list of determined codec pairs. Accordingly, the list of codec pairs can be prioritized based on the degradation to a quality of service factor associated with the ingress transmission (as determined from the list of predetermined codec pairs).

In one or more embodiments, the call server 102 may receive a transcoding policy. For example, the transcoding policy may be associated with the egress trunk groups or with the destination 106 or both. The transcoding policy may have been transmitted by the destination to the call server 102 (to be stored in a memory for later access). The prioritization of a list of codec pairs is further based the transcoding policy. For example, the prioritization may take into account certain indications in the transcoding policy regarding the desirability of using one codec over another.

The call server 102 (or a related component) can store the prioritized list of codecs. For example, the prioritized list of codecs can be stored in a memory or in the database 210. Prioritizing the list of codecs can include determining an ordered list of codec pairs. The ordered list can be ordered on the bases of one or more metrics, such as the effect transcoding between a given pair can have on a quality of service associated with the transcoded data. Each codec pair in the prioritized list of codecs can be stored in association with the trunk group(s) that offers the respective codec, for example.

At 310, one trunk group is selected from the egress trunk group list. The selected trunk group can have a codec profile that includes a codec from a codec pair in the prioritized list of codec pairs. The call server 102 may perform the trunk group selection.

In one or more embodiment, the call server 102 (or an associated network component) may use the prioritized list of codec pairs to select the trunk group. For example, the call server 102 may select the trunk group that is associated with the egress codec that is in the highest priority codec pair. The trunk group may have been stored in memory in association with the codec pair in the prioritized list. The trunk group selected from the egress trunk group list can be associated with more than one codec. In such a situation the call server 102 may select one codec from those associated with the selected trunk group. Similarly, more than one trunk group may be associated with a (or the highest priority) codec pair, in which case the call server 102 may select one of the more than one trunk group (e.g. randomly or using other predetermined criteria).

At 312, the ingress transmission is received from the sender 104. The ingress transmission can include data that is transmitted in accordance with VoIP, for example. The ingress transmission can include other types of data and may be transmitted over transmission medium 108,110. In one or more embodiments, the transmission medium may be wireless.

In one or more embodiments, the ingress transmission is associated with a sender 104. A response to the ingress transmission may be transmitted to the sender (for example, SIP 200 OK). The response can identify a codec profile associated with the selected trunk group. The transmission of the response to the sender can occur before receiving the ingress transmission from the sender (at 312).

Optionally, the sender 104 may transmit an acknowledgment of the response back to the call server 102 indicating that acceptance of the identified codec profile associated with the selected trunk group.

At 314, the ingress transmission may be transmitted to the destination 106 over the selected egress trunk group. The carrier operating the selected egress trunk group list may be responsible for managing the transcoding (if necessary) from the ingress codec to the egress codec.

In an alternative embodiment, a negotiation may occur between the call server 102 (or another network component) and the destination 106 or the carrier operating the selected egress trunk group. For example, the transcoding policy for the selected egress trunk group may not have been used (or may not have been available or may have been out of date) by the call server 102 in determining the highest priority codec pairs. Accordingly, a selection of codec pairs and (optionally) their associated priority rankings form the prioritized list may be transmitted to the selected trunk group to allow the selected trunk group (or it operator) to select a codec pair. The operator may select a codec pair based on the transcoding policy associated with the trunk group or based on one or more other factors. In one or more embodiments, the call server 102 may negotiate with respect to multiple trunk groups (who may be operated by the same carrier) in order to determine the codec pair that is most acceptable to the operator of the egress trunk groups (and/or the destination 106) and which still maintains an approximate optimal effect of one or more quality of service factors (whose identification may be predetermined).

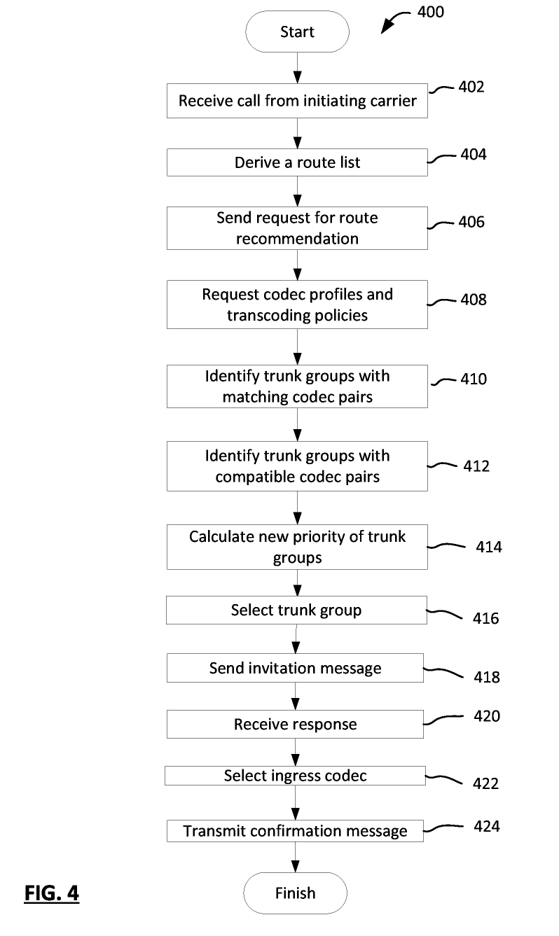

FIG. 4 depicts an embodiment of a method 400 of optimizing a route selection to connect an incoming phone call with a destination based on codec profile and transcoding policy. The method 400 can be performed at the call server 102 that may be used to coordinate or oversee connections between carriers which can be used to transmit data (such as using VoIP). For example, the method may be used to connect phone calls over a network infrastructure such as the internet.

At 402, a call is received from an initiating carrier (who may be the sender 104, for example). The call may be received at the call server 102 after being transmitted through a trunk group which may be identified as the ingress trunk group. The ingress trunk group may be associated with the initiating carrier and may be capable of encoding and decoding voice data transmissions in accordance with one or more coding or encoding methods or standards. The call may be transmitted using a protocol suitable for transmitting audio over an existing network infrastructure (such as the internet). The call may include identification of preferred codec list by the initiating carrier.

At 404, a route list is derived. The route list can be derived by the call server 102, for example, and may be stored in the database 210 or in another memory associated with the call server 102. The route list can contain an identification of one or more outgoing or egress trunk groups that can potentially be used to route the call between the initiating carrier (e.g. the sender 104) and the destination carrier (e.g. the destination 106). The route list may include a priority listing of trunk groups for the destination carrier (e.g. which operates one or more destination(s) 106) that may be predefined. For example, the priority listing of trunk groups may be stored in the database 210 or in memory associated with the call server 102. The listing of the trunk groups may have been prioritized at the destination carrier and this prioritized listing of available trunk groups may have been provided to the call server 102 (or an associated network component).

At 406 a request is sent to a processor requesting a route recommendation. The processor (which may also be called a transcoding logic module and which may execute transcoding logic) may be associated with the call server 102, for example. The call server 102 and the processor (or transcoding logic module) may be in different physical locations or the processor may be part of the call server 102. The request can be transmitted from the call server 102, for example. The request can be implemented using a communication protocol, such as Enum, SIP, HTTP, SOAP/XML, LDAP, Radius, Diameter, or another suitable protocol. The request may include an identification of the ingress transmission and the current route list (including priorities) for the egress trunk groups or for the destination carrier.

At 408, a codec profile and a transcoding policy for each egress trunk group are then obtained from a transcoding policy repository. For example, a request may be sent to a transcoding policy repository requesting the codec profile and the transcoding policy for each egress trunk group. The transcoding policy may be stored in the database 210, for example. This request may be transmitted from the call server 102 or from the processor (or transcoding logic module). The codec profiles and transcoding policies may be obtained by the transcoding logic module (or processor) or they may be obtained by the call server 102 and transmitted (or made available) to the transcoding logic module.

In one or more embodiments, the transcoding logic module (or processor) can store the transcoding policies and codec profiles in an associated cache memory. A data synchronization mechanism may be implemented between the transcoding policy repository and the transcoding logic module in order to periodically store a most recent version codec profiles and transcoding policies in a memory associated with the transcoding logic module.

At 410, the egress trunk groups that have codec profiles that identify a codec that is listed in the call request (or the ingress transmission) and (optionally) in the ingress codec profile (i.e. the codec profile associated with the ingress trunk group) are identified. For example, the processor (or the transcoding logic module) may determine the list of trunk groups associated with the destination carrier that are capable of (or available to) handle data transmitted in accordance with one or more of the codecs that are in the call request (or ingress transmission) as well as listed in the codec profile associated with the initiating carrier. The identification of egress trunk groups may be obtained by the call server 102.

At 412, the egress trunk groups that have codec profiles that identify a codec that is compatible with a codec in the call request (or ingress transmission) and optionally also listed in the ingress trunk group are identified. For example, this identification may be carried out by the processor (or the transcoding logic module). The identification of the egress trunk groups may be obtained by the call server 102.

In one or more embodiments, the call server 102 obtains the identification of all of the egress trunk groups identified at 410 and 412 after the identification at 412 is made.

At 414, a new priority of trunk groups from the route list is calculated. The calculation may be performed using at the transcoding logic module, for example, or at the call server 102. The calculation may be based on the original (or current) route list and its associated priority, and the codecs available in each egress trunk group identified at 410 and 412. The calculation may be subject to the preferences of the operator of the call server 102. Additionally, the calculation may be based on the trunk groups that minimize the degradation to the data being transmitted. For example, the calculation may be based on the amount of degradation to the data after transcoding is applied to transcode the data from the ingress codec to the egress codec (the degradation values may be known in advance, for example). In one or more embodiments, the call server 102 (or processor, e.g.) may weigh one or more of these factors depending on personal or different preferences. The result of the calculation is a list of available egress trunk groups in prioritized format.

In one or more embodiments, the new prioritized route list is obtained from the transcoding logic module by the call server 102. This may be performed through a push or pull operation.

At 416, a trunk group is selected from the newly prioritized route list. In other words, the trunk group may be selected from the list of egress trunk groups in accordance with the prioritization of the trunk groups. In one or more embodiments, this selection may be performed by the call server 102. Alternatively, this selection may be performed by the transcoding logic module.

The call server 102 may then identify and list the codecs from the codec profile for the selected egress trunk group. For example, the codec profile may be accessed from the database 210 and the codecs listed in the codec profile may be compared to those codecs listed in the codec profile associated with the ingress trunk group.

At 418, an invitation message is sent to the destination carrier. For example, the invitation message may be sent to the destination 106. In one or more embodiments, the Session Description Protocol (“SDP”) as defined in IETF RFC 4566 is the protocol that may be used for codec negotiation. The invitation message can include an identification of the selected egress trunk group and the list of identified codecs from the codec profile of the selected egress trunk group. In one or more embodiments, the codec list may be prioritized based on the degradation to one or more quality of service factors that results from transmitting data using the respective codec.

At 420, a response is received from the egress carrier including a selection of a codec from the codec list in the invitation message. The codec identified on the codec list may be selected based on a preference of the destination carrier. In an embodiment in which the list of codecs is prioritized (e.g. based on quality of service degradation resulting from transmission using the respective codec), the destination carrier may take into account the prioritization when selecting a codec from the list.

At 422, the call server 102 selects a codec from the codec profile associated with the ingress trunk group. The codec may be selected on the basis of the level or amount of degradation to one or more quality of service factors that would result from transmitting the call using the selected ingress codec and the selected egress codec.

At 424, a confirmation message is transmitted to the egress carrier. The confirmation message can include the codec selected from the codec profile associated with the ingress trunk group at 422.

There may be situations in which no common codecs and no compatible codecs are found or located or calculated or determined at the call server 102 (or at an associated network component). In other words, there may not be any codecs listed in any of the egress trunk group profiles that are either compatible with or common to any known codecs in the codec profile associated with the ingress trunk group (or initiating carrier). Similarly, in one or more embodiments the codec profile or one or more codecs in the codec profile associated with the initiating carrier or the ingress trunk group may not be known at the call server. In such situations the call server 102 may initiate internal call re-routing procedures to redirect the call to a pre-configured pool of routing terminations. For example, there may be a third carrier that is used to re-route the call or transmission.

After the ingress codec and egress codec are determined the transmission route is available to transmit voice data, call data or other data. The data will be transmitted using the ingress codec and, if necessary (i.e. if the two codecs don't match), the data will be transcoded into the egress codec and the transmission will be completed using the egress codec.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method of selecting a route for an ingress transmission from an egress trunk group list, the egress trunk group list identifying one or more egress trunk groups, the method comprising:
receiving an ingress codec profile and an identification of a destination, the ingress codec profile comprising an identification of one or more codecs;
determining whether there is a matching codec pair, a matching codec pair comprising a codec that is identified in both the ingress codec profile and one or more egress codec profile, the egress codec profiles associated with the egress trunk groups identified in the egress trunk group list;
identifying one or more compatible codec pairs between the codecs listed in the ingress codec profile and the codecs listed in the egress codec profiles associated with the egress trunk groups identified in the egress trunk group list;
prioritizing a list of codec pairs, each codec pair in the list of codec pairs comprising a codec identified in the ingress codec profile and a codec identified in an egress codec profile, the prioritization based on the determination of matching codec pairs and the determination of compatible codec pairs; and,
selecting one trunk group from the egress trunk group list, the selected trunk group having a codec profile that comprises a codec from a codec pair in the prioritized list of codec pairs.

2. The method of claim 1, wherein prioritizing a list of codec pairs comprises prioritizing a list of codec pairs based on the degradation to a quality of service factor associated with the ingress transmission.

3. The method of claim 2 wherein prioritizing further comprises determining an ordered list of codec pairs.

4. The method of claim 1, further comprising receiving a transcoding policy identifying a trunk group priority associated with the destination, and wherein the prioritization of a list of codec pairs is further based the transcoding policy.

5. The method of claim 1, wherein a compatible codec pair comprises a codec pair that results in a degradation of a quality of service factor of less than a predetermined threshold.

6. The method of claim 1, wherein the ingress transmission is associated with a sender, the method further comprising transmitting a response to the sender, the response comprising an identification of a codec profile associated with the selected trunk group.

7. The method of claim 6, further comprising:
receiving the ingress transmission from the sender; and,
transmitting the ingress transmission to the destination on the selected egress trunk group.

8. The method of claim 7, wherein the ingress transmission is encoded using an ingress codec, the method further comprising:
selecting a codec from the codec profile associated with the selected trunk group;
determining that the selected codec profile is different from the ingress codec profile; and
transcoding the ingress transmission from the ingress codec profile to the selected codec profile.

9. The method of claim 1, wherein determining whether there is a matching codec pair further comprises determining all of the matching codec pairs.

10. The method of claim 1, wherein identifying one or more compatible codec pairs further comprises identifying all compatible codec pairs.

11. The method of claim 1 wherein identifying one or more compatible codec pairs comprises identifying one or more codec pairs that satisfy a transcoding policy associated with the ingress transmission.

12. The method of claim 1 wherein identifying one or more compatible codec pairs comprises identifying one or more codec pairs that satisfy a transcoding policy associated with an egress trunk group.

13. A call server for selecting a route for an ingress transmission from an egress trunk group list, the call server configured to:
receive an ingress codec profile and an identification of a destination, the ingress codec profile comprising an identification of one or more codecs;
determine whether there is a matching codec pair, a matching codec pair comprising a codec that is identified in both the ingress codec profile and one or more egress codec profile, the egress codec profiles associated with the egress trunk groups identified in the egress trunk group list;
identify one or more compatible codec pairs between the codecs listed in the ingress codec profile and the codecs listed in the egress codec profiles associated with the egress trunk groups identified in the egress trunk group list;
prioritize a list of codec pairs, each codec pair in the list of codec pairs comprising a codec identified in the ingress codec profile and a codec identified in an egress codec profile, the prioritization based on the determination of matching codec pairs and the determination of compatible codec pairs; and,
select one trunk group from the egress trunk group list, the selected trunk group having a codec profile that comprises a codec from a codec pair in the prioritized list of codec pairs.

14. The call server of claim 13, further comprising a database associated with the call server, the database for storing the prioritized list.

15. The call server of claim 14, wherein the databases is further configured to store the egress trunk group list.

16. The call server of claim 13, wherein prioritizing a list of codec pairs comprises prioritizing a list of codec pairs based on the degradation to a quality of service factor associated with the ingress transmission.

17. The call server of claim 16, wherein prioritizing further comprises determining an ordered list of codec pairs.

18. The call server of claim 13, wherein the ingress transmission is associated with a sender, the method further comprising transmitting a response to the sender, the response comprising an identification of a codec profile associated with the selected trunk group.

19. The call server of claim 18, wherein the call server is further configured to:
receive the ingress transmission from the sender; and,
transmit the ingress transmission to the destination on the selected egress trunk group.

20. The call server of claim 19, wherein the ingress transmission is encoded using an ingress codec, and wherein the call server is further configured to:
select a codec from the codec profile associated with the selected trunk group;
determining that the selected codec profile is different from the ingress codec profile; and,
transcoding the ingress transmission from the ingress codec profile to the selected codec profile.
